(19) United States
(12) Patent Application Publication
(10) Pub. No.: US 2013/0081658 A1
(43) Pub. Date: Apr. 4, 2013

(54) APPARATUS AND METHOD FOR TREATING SUBSTRATE

(71) Applicants: Gil Hun SONG, Cheonan-si (KR); Jeong Yong BAE, Cheonan-si (KR); Kyo Woog KOO, Cheonan-si (KR)

(72) Inventors: Gil Hun SONG, Cheonan-si (KR); Jeong Yong BAE, Cheonan-si (KR); Kyo Woog KOO, Cheonan-si (KR)

(73) Assignee: SEMES CO., LTD., Cheonan-si (KR)

(21) Appl. No.: 13/609,986

(22) Filed: Sep. 11, 2012

(30) Foreign Application Priority Data
Sep. 30, 2011 (KR) 10-2011-0100312
Dec. 22, 2011 (KR) 10-2011-0140017

(51) Int. Cl. B08B 3/00

(52) U.S. Cl. 134/25.1; 134/198

(57) ABSTRACT

Provided are an apparatus and method for treating a substrate through a supercritical process. The apparatus includes a housing providing a space for performing a process, and a plurality of support members vertically arranged in the housing at predetermined intervals to support edges of substrates, respectively.

### CROSS-REFERENCE TO RELATED APPLICATIONS

This U.S. non-provisional patent application claims priority under 35 U.S.C. §119 of Korean Patent Application Nos. 10-2011-0100312, filed on Sep. 30, 2011, and 10-2011-0140017, filed on Dec. 22, 2011, the entire contents of which are hereby incorporated by reference.

### BACKGROUND OF THE INVENTION

The present invention disclosed herein relates to an apparatus and method for treating a substrate, and more particularly, to an apparatus and method for treating a substrate through a supercritical process.

Semiconductor devices are manufactured by forming circuit patterns on a substrate through various processes such as a photolithography process. During such processes, contaminants such as particles, organic contaminants, and metallic impurities are generated, which cause defects on a substrate and affect the yield of semiconductor device manufacturing processes. Therefore, cleaning processes are included in semiconductor device manufacturing processes to remove such contaminants.

Generally, a cleaning process is performed by removing contaminants from a substrate using a detergent, washing the substrate using deionized water (DI water), replacing the DI water with an organic solvent having low surface tension such as isopropyl alcohol (IPA), and evaporating the organic solvent. However, semiconductor devices having fine circuit patterns are not satisfactorily dried, and the fine circuit patterns may easily collapse even by low surface tension of an organic solvent during a drying process.

Thus, as a drying process, the use of a supercritical drying process increases, in which a supercritical fluid is used to dry semiconductor devices having a line width of about 30 nm or lower. Supercritical fluids mean any substance being at a temperature and pressure above its critical point and having both the gas and liquid properties. Supercritical fluids are outstanding in diffusion ability, permeation ability, and dissolving other substrates, and have little surface tension. Thus, supercritical fluids can be usefully used for dying substrates.

However, a process chamber for performing a supercritical process has a large foot print to maintain a high-pressure supercritical state, and thus the substrate throughput thereof is low. Therefore, much research is being conducted on process chamber structures for improving spatial efficiency.

### SUMMARY OF THE INVENTION

The present invention provides an apparatus and method for treating a plurality of substrates at the same time.

The present invention also provides an apparatus and method for efficiently injecting a supercritical fluid to a plurality of substrates.

The present invention is not limited thereto. Other features and spirit of the present invention will be apparently understood by those skilled in the art through the following description and accompanying drawings.

Embodiments of the present invention provide apparatuses for treating substrates.

The apparatuses include: a housing providing a space for performing a process; and a plurality of support members vertically arranged in the housing at predetermined intervals to support edges of substrates, respectively.

In some embodiments, the apparatuses may further include a nozzle member having an end through which a process fluid may be injected, the end being disposed between neighboring substrates when viewed from a side.

In other embodiments, the end of the nozzle member may be aligned with a center portion of a substrate when viewed from a top.

In still other embodiments, the nozzle member may inject the process fluid toward a topside of a lower one of the neighboring substrates.

In even other embodiments, the nozzle member may inject the process fluid toward both a topside of a lower one of the neighboring substrates and a bottom side of an upper one of the neighboring substrates.

In yet other embodiments, the nozzle member may inject the process fluid in a radial pattern in oblique directions from a vertical direction.

In further embodiments, the end of the nozzle member may be positioned at an edge portion of a substrate or outside the substrate to inject the process fluid in a direction parallel with the substrate.

In still further embodiments, the apparatuses may further include a lower supply port disposed in a lower wall of the housing for injecting the process fluid.

In even further embodiments, the apparatuses may further include an upper supply port disposed in an upper wall of the housing for injecting the process fluid.

In yet further embodiments, the apparatuses may further include a controller configured to control supply of the process fluid in a manner such if an inside pressure of the housing reaches a preset value after the process fluid may be supplied through the lower supply port, the nozzle member starts to inject the process fluid.

In some embodiments, the apparatuses may further include a support bar extending downward from an upper wall of the housing, wherein the support members may be disposed on the support bar at regular intervals.

In other embodiments, the housing may include an upper housing and a lower housing under the upper housing, and the apparatuses may further include a lift member configured to lift or lower one of the upper housing and the lower housing to close or open the housing.

In still other embodiments, the process fluid may be a supercritical fluid.

In other embodiments of the present invention, there are provided apparatuses for treating substrates, the apparatuses include: a housing providing a space for performing a process; a first support member configured to support an edge of a first substrate; a second support member configured to support an edge of a second substrate; and an upper supply port disposed in an upper wall of the housing to inject a supercritical fluid to a topside of the second substrate.

In some embodiments, the apparatuses may further include a nozzle member having an end through which the supercritical fluid may be injected, the end being disposed between the first and second support members when viewed from a side.

In other embodiments, the nozzle member may inject the supercritical fluid toward a topside of the second substrate.

In still other embodiments, the nozzle member may inject the supercritical fluid to a gap between the first and second substrates.

In even other embodiments, the apparatuses may further include a support bar extending downward from the upper wall of the housing, wherein the first support member may extend horizontally from a lower end of the support bar, and the second support member may extend horizontally from a middle of the support bar.

In still other embodiments of the present invention, there is provided methods for treating substrates, the methods including: placing a plurality of substrates on a plurality of support members vertically arranged at predetermined intervals in a housing proving a space for performing a process, the support members supporting edges of the substrates; and injecting a process fluid through a nozzle member for treating the substrates at the same time, an end of the nozzle member being disposed between neighboring substrates when viewed from a side.

In some embodiments, the nozzle member may inject the process fluid toward a topside of a lower one of the neighboring substrates so as to treat the topside of the lower substrate.

In other embodiments, the nozzle member may inject the process fluid to a gap between the neighboring substrates so as to simultaneously treat a bottom side of an upper one of the neighboring substrates and a topside of a lower one of the neighboring substrates.

In still other embodiments, the housing may include an upper housing and a lower housing under the upper housing, wherein the housing may be opened or closed by lowering or lifting one of the upper housing and the lower housing, the substrates may be carried into and out of the housing when the housing is opened, and a process may be performed in the housing when the housing is closed.

In even other embodiments, the process fluid may be a supercritical fluid.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a phase diagram of carbon dioxide;

FIG. 2 is a plan view illustrating a substrate treating apparatus according to an embodiment of the present invention;

FIG. 3 is a sectional view illustrating a first process chamber depicted in FIG. 2, according to an embodiment of the present invention;

FIGS. 4 through 5 are sectional views illustrating a second process chamber depicted in FIG. 2, according to an embodiment of the present invention;

FIG. 6 is a sectional view illustrating the second process chamber depicted in FIG. 2, according to another embodiment of the present invention;

FIGS. 7 and 8 are view illustrating exemplary end shapes of a nozzle member illustrated in FIGS. 4 and 5;

FIG. 9 is a view illustrating the nozzle member of FIG. 7 when a supercritical fluid is injected through the nozzle member;

FIG. 10 is a view illustrating a modification example of the nozzle member illustrated in FIGS. 4 and 5;

FIG. 11 is a flowchart for explaining a substrate treating method according to an embodiment of the present invention;

FIG. 12 is a flowchart for explaining another embodiment of the substrate treating method; and

FIGS. 13 and 14 are views illustrating the second process chamber when the substrate treating method of FIG. 12 is performed.

### DETAILED DESCRIPTION OF PREFERRED EMBODIMENTS

In the following description, terms and drawings are used for explaining embodiments of the present invention while not limiting the present invention.

Known techniques used in the present invention but not related to the concept of the present invention will not be explained in detail.

Hereinafter, a substrate treating apparatus 100 will be described according to exemplary embodiments of the present invention.

The substrate treating apparatus 100 may be used to perform a supercritical process for treating a substrate (S) using a supercritical fluid as a process fluid.

The term “substrate (S)” is used herein to denote any substrate used to manufacture a product such as a semiconductor device and a flat panel display (FPD) in which circuit patterns are formed on a thin film. Examples of substrates (S) include wafers such as silicon wafers, glass substrates, and organic substrates.

The term “supercritical fluid” means any substance having both the gas and liquid characteristics because the phase of the substance is in a supercritical state above its critical temperature and pressure. A supercritical fluid has molecular density close to that of liquid and viscosity close to that of gas, and is thus outstanding in diffusion ability, permeation ability, and dissolving other substances. Therefore, a supercritical fluid is advantageous in chemical reaction. In addition, a supercritical fluid has little surface tension, and thus applies little interfacial tension to microstructures.

Supercritical processes are performed using the properties of a supercritical fluid, and examples of supercritical processes include a supercritical drying process and a supercritical etch process. Hereinafter, a supercritical process will be explained based on a supercritical drying process. Although the following explanation is given based on a supercritical drying process for conciseness of the explanation, the substrate treating apparatus 100 can be used for performing other supercritical processes.

A supercritical drying process may be performed to dissolve an organic solvent remaining on circuit patterns of a substrate (S) in a supercritical fluid and dry the substrate (S). In this case, satisfactory dry efficiency may be obtained while preventing pattern collapse. A substance miscible with an organic solvent may be used as a supercritical fluid in a supercritical drying process. For example, supercritical carbon dioxide (scCO₂) may be used as a supercritical fluid.

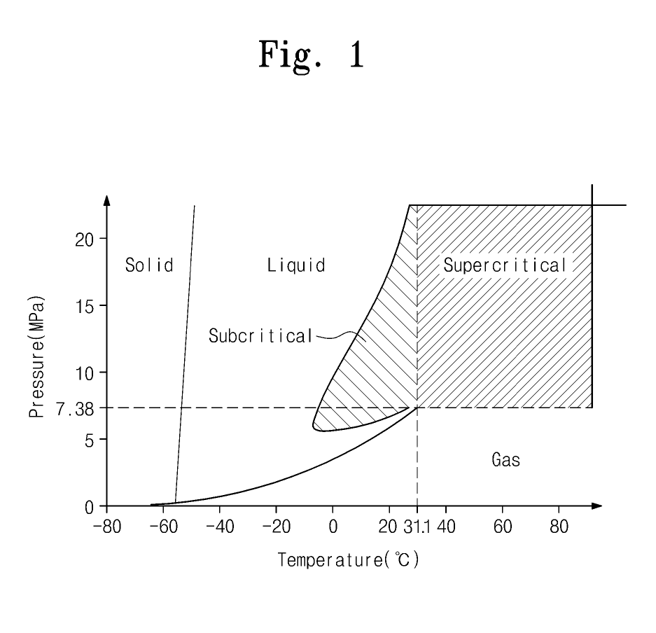

FIG. 1 is a phase diagram of carbon dioxide.

Since carbon dioxide has a relatively low critical temperature of 31.1° C. and critical pressure of 7.38 Mpa, it is easy to make carbon dioxide supercritical and control the phase of carbon dioxide by adjusting temperature and pressure. In addition carbon dioxide is inexpensive. In addition, carbon dioxide is nontoxic, harmless, nonflammable, and inert, and has a diffusion coefficient about ten to hundred times the diffusion coefficient of water or other organic solvents to rapidly permeate and replace an organic solvent. Furthermore, carbon dioxide has little surface tension. That is, the properties of carbon dioxide are suitable for drying a substrate (S) having fine patterns. In addition, carbon dioxide obtained from byproducts of various chemical reactions can be reused, and carbon dioxide used in a supercritical drying process can be separated from an organic solvent by vaporizing the carbon dioxide for reusing the carbon dioxide. That is, carbon dioxide is environmentally friendly.

Hereinafter, the substrate treating apparatus 100 will be described according to an embodiment of the present invention. The substrate treating apparatus 100 of the embodiment may be used to perform a cleaning process including a supercritical drying process.

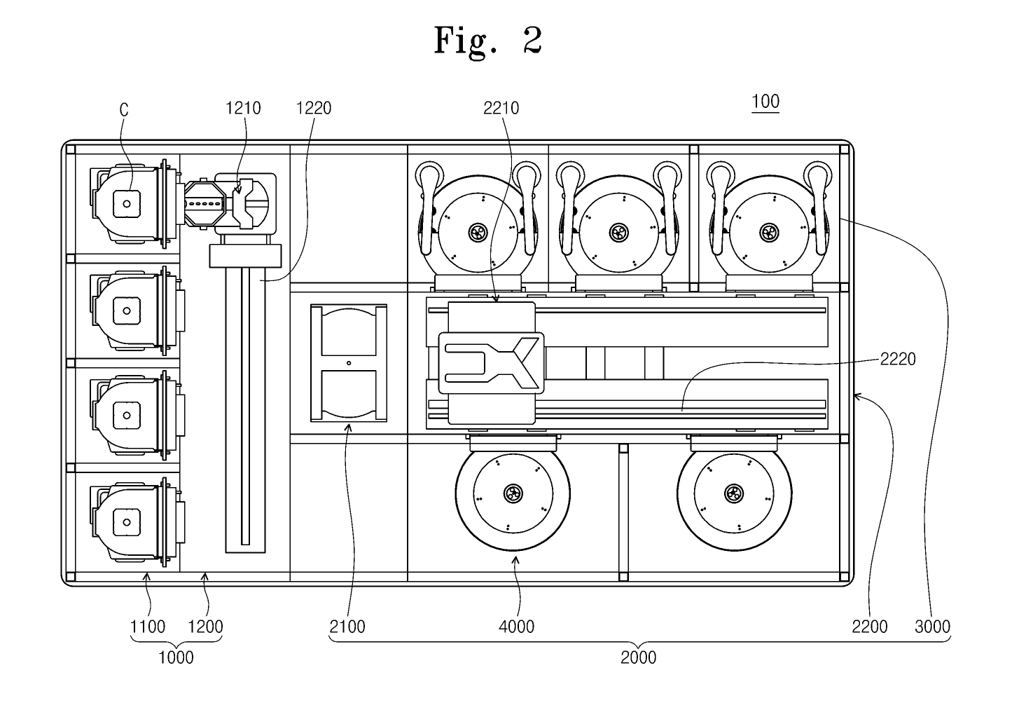

FIG. 2 is a plan view illustrating the substrate treating apparatus 100 according to an embodiment of the present invention.

Referring to FIG. 2, the substrate treating apparatus 100 includes an index module 1000 and a process module 2000.

The index module 1000 may receive substrates (S) from an external apparatus and carry the substrates (S) to the process module 2000, and the process module 2000 may perform a supercritical drying process.

The index module 1000 is an equipment front end module (EFEM) and includes load ports 1100 and a transfer frame 1200.

Containers (C) in which substrates (S) are stored are placed on the load ports 1100. Front opening unified pods (FOUPs) may be used as containers (C). Containers (C) may be carried to the load ports 1100 from an outside area or carried from the load ports 1100 to an outside area via an overhead transfer (OHT).

The transfer frame 1200 carries substrates (S) between the containers (C) placed on the load ports 1100 and the process module 2000. The transfer frame 1200 includes an index robot 1210 and an index rail 1220. The index robot 1210 may carry a substrate (S) while moving on the index rail 1220.

The process module 2000 is a module in which processes are actually performed. The process module 2000 includes a buffer chamber 2100, a transfer chamber 2200, a first process chamber 3000, and a second process chamber 4000.

A substrate (S) is temporarily stored in the buffer chamber 2100 while being carried between the index module 1000 and the process module 2000. A buffer slot may be formed in the buffer chamber 2100 to place a substrate (S) therein. For example, the index robot 1210 may pick up a substrate (S) from a container (C) and place the substrate (S) in the buffer slot, and a transfer robot 2210 of the transfer chamber 2200 may pick up the substrate (S) from the buffer slot and transfer the substrate (S) to the first process chamber 3000 or the second process chamber 4000. A plurality of buffer slots may be formed in the buffer chamber 2100 so that a plurality of substrates (S) can be placed in the buffer chamber 2100.

A substrate (S) is carried among the buffer chamber 2100, the first process chamber 3000, and the second process chamber 4000 through the transfer chamber 2200. The transfer chamber 2200 may include the transfer robot 2210 and a transfer rail 2220. The transfer robot 2210 may carry a substrate (S) while moving on the transfer rail 2220.

The first process chamber 3000 and the second process chamber 4000 may be used to perform a cleaning process. Procedures of a cleaning process may be sequentially performed in the first process chamber 3000 and the second process chamber 4000. For example, a chemical process, a rinsing process, and an organic solvent process of a cleaning process may be performed in the first process chamber 3000, and a supercritical drying process of the cleaning process may be performed in the second process chamber 4000.

The first process chamber 3000 and the second process chamber 4000 are disposed on sides of the transfer chamber 2200. For example, the first process chamber 3000 and the second process chamber 4000 may disposed on opposite sides of the transfer chamber 2200 to face each other.

The process module 2000 may include a plurality of first process chambers 3000 and a plurality of second process chambers 4000. In this case, the first process chambers 3000 and the second process chambers 4000 may be arranged in lines along sides of the transfer chamber 2200 or may be vertically stacked along the sides of the transfer chamber 2200. In addition, the first process chambers 3000 and the second process chambers 4000 may be arranged in a combination of the above-mentioned manners.

Arrangement of the first process chambers 3000 and the second process chambers 4000 is not limited to the above-mentioned manner. That is, the first process chambers 3000 and the second process chambers 4000 may be arranged in various manners in consideration of the footprint or processing efficiency of the substrate treating apparatus 100.

Hereinafter, the first process chamber 3000 will be described in detail.

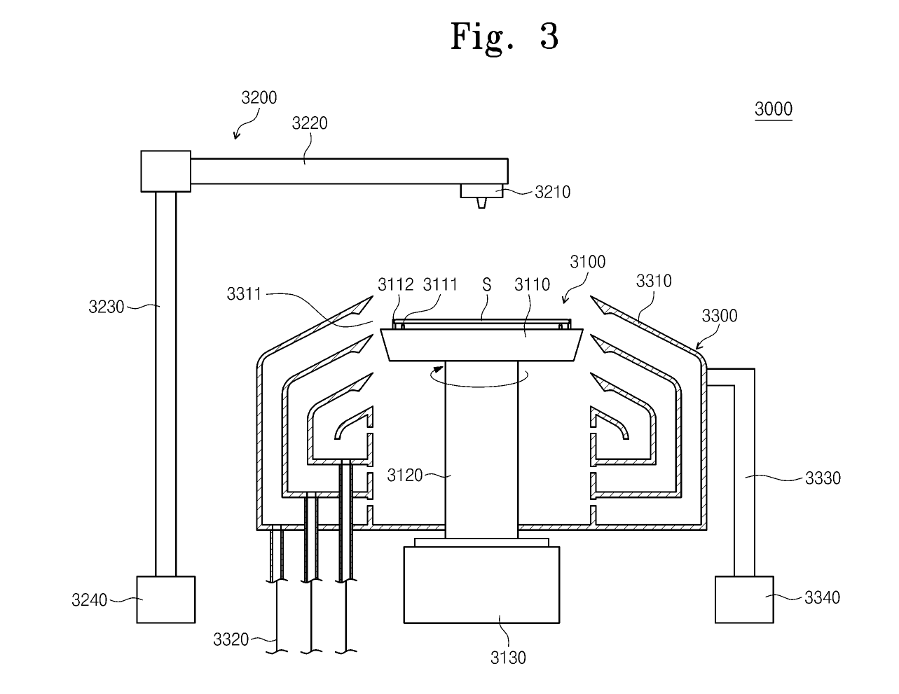

FIG. 3 is a sectional view illustrating the first process chamber 3000 depicted in FIG. 2.

The first process chamber 3000 may be used to perform a chemical process, a rinsing process, and an organic solvent process. Alternatively, the first process chamber 3000 may be used to perform some of such processes. The chemical process may be performed to remove contaminants from a substrate (S) by applying a detergent to the substrate (S), the rinsing process may be performed to remove the detergent remaining on the substrate (S) by applying a rinsing agent to the substrate (S), and the organic solvent process may be performed to replace the rinsing agent remaining between circuit patterns of the substrate (S) with an organic solvent having low surface tension.

Referring to FIG. 3, the first process chamber 3000 includes a support member 3100, a nozzle member 3200, and a collecting member 3300.

The support member 3100 may support a substrate (S) and rotate the substrate (S). The support member 3100 may include a support plate 3110, support pins 3111, chucking pins 3112, a rotation shaft 3120, and a rotary actuator 3130.

The support plate 3110 has a top surface shaped like a substrate (S), and the support pins 3111 and the chucking pins 3112 are provided on the top surface of the support plate 3110. The support pins 3111 may support a substrate (S), and the chucking pins 3112 may hold the substrate (S) firmly.

The rotation shaft 3120 is connected to the bottom side of the support plate 3110. The rotation shaft 3120 receives rotation power from the rotary actuator 3130 and rotates the support plate 3110. Thus, a substrate (S) placed on the support plate 3110 can be rotated. At this time, the chucking pins 3112 prevent the substrate (S) from departing from a set position.

The nozzle member 3200 injects a chemical to the substrate (S). The nozzle member 3200 includes a nozzle 3210, a nozzle bar 3220, a nozzle shaft 3230, and a nozzle shaft actuator 3240.

The nozzle 3210 is used to inject a chemical to the substrate (S) placed on the support plate 3110. The chemical may be a detergent, a rinsing agent, or an organic solvent. Examples of the detergent may include: a hydrogen peroxide (H₂O₂) solution; a solution prepared by mixing a hydrogen peroxide solution with ammonia (NH₄OH), hydrochloric acid (HCl), or sulfuric acid (H₂SO₄); and a hydrofluoric acid (HC) solution. The rinsing agent may be pure water. Examples of the organic solvent may include: isopropyl alcohol, ethyl glycol, 1-propanol, tetrahydrofuran, 4-hydroxy-4-methyl-2-pentanone, 1-butanol, 2-butanol, methanol, ethanol, n-propyl alcohol, and dimethyl ether. Such organic solvents may be used in the form of a solution or gas.

The nozzle 3210 is provided on a lower side of an end of the nozzle bar 3220. The nozzle bar 3220 is coupled to the nozzle shaft 3230, and the nozzle shaft 3230 can be lifted or rotated. The nozzle shaft actuator 3240 may lift or rotate the nozzle shaft 3230 to adjust the position of the nozzle 3210.

The collecting member 3300 collects a supplied chemical. If a chemical is supplied to the substrate (S) through the nozzle member 3200, the support member 3100 may rotate the substrate (S) so as to distribute the chemical uniformly to the entire area of the substrate (S). When the substrate (S) is rotated, the chemical may scatter from the substrate (S). The collecting member 3300 collects the chemical scattering from the substrate (S).

The collecting member 3300 may include a collecting vessel 3310, a collecting line 3320, a lift bar 3330, and a lift actuator 3340.

The collecting vessel 3310 has a ring shape surrounding the support plate 3110. A plurality of collecting vessels 3310 may be provided. In this case, the collecting vessels 3310 may have ring shapes sequentially spaced apart from the support plate 3110 when viewed from the topside. The more distant the collecting vessel 3310 is from the support plate 3110, the higher the collecting vessel 3310 is. Collecting slots 3311 are formed between the collecting vessels 3310 to receive a chemical scattering from the substrate (S).

The collecting line 3320 is formed on the bottom side of the collecting vessel 3310. A chemical collected in the collecting vessel 3310 is supplied to a chemical recycling system (not shown) through the collecting line 3320.

The lift bar 3330 is connected to the collecting vessel 3310 to receive power from the lift actuator 3340 and move the collecting vessel 3310 vertically. If a plurality of collecting vessels 3310 are provided, the lift bar 3330 may be connected to the outermost collecting vessel 3310. The lift actuator 3340 may lift or lower the collecting vessels 3310 using the lift bar 3330 so as to adjust the position of one of the collecting slots 3311 when a scattering chemical is collected through the one of the collecting slots 3311.

Hereinafter, the second process chamber 4000 will be described in detail.

The second process chamber 4000 may be used to perform a supercritical drying process using a supercritical fluid. As described above, the second process chamber 4000 may be used to perform other processes as well as a supercritical drying process. In addition, the second process chamber 4000 may be used to perform a process using a process fluid other than a supercritical fluid.

The second process chamber 4000 may be disposed at a side of the transfer chamber 2200. A plurality of second process chambers 4000 may be provided. In this case, the second process chambers 4000 may be arranged in a line along a side of the transfer chamber 2200 or may be vertically stacked along the side of the transfer chamber 2200. In addition, the second process chambers 4000 may be arranged in a combination of the above-mentioned manners. In the substrate treating apparatus 100, the load ports 1100, the transfer frame 1200, the buffer chamber 2100, and the transfer chamber 2200 may be sequentially arranged in a direction, and the second process chambers 4000 may be arranged along a side of the transfer chamber 2200 in the direction.

Hereinafter, the second process chamber 4000 will be described according to an embodiment of the present invention.

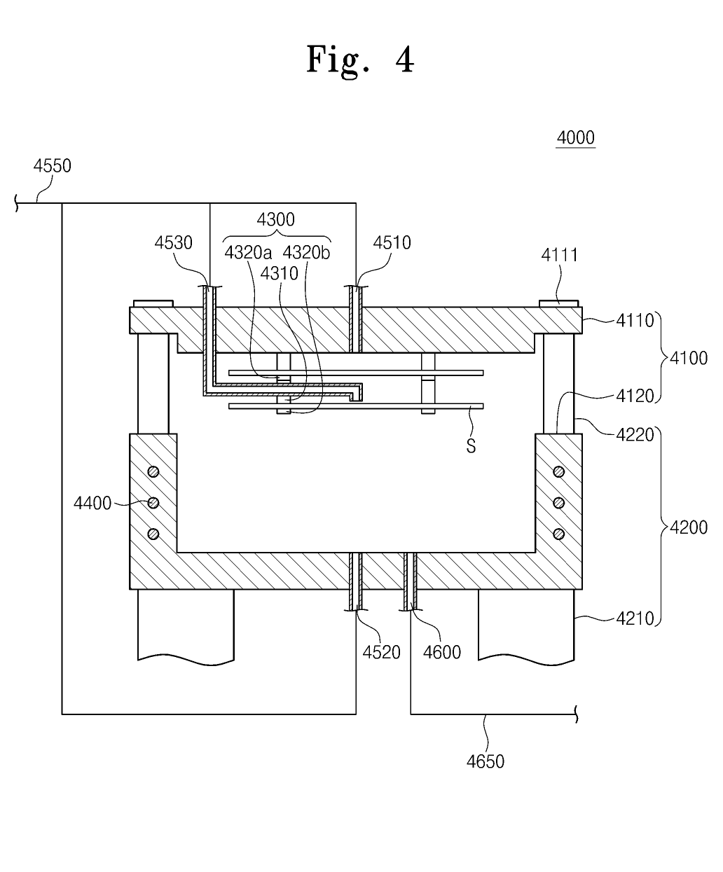

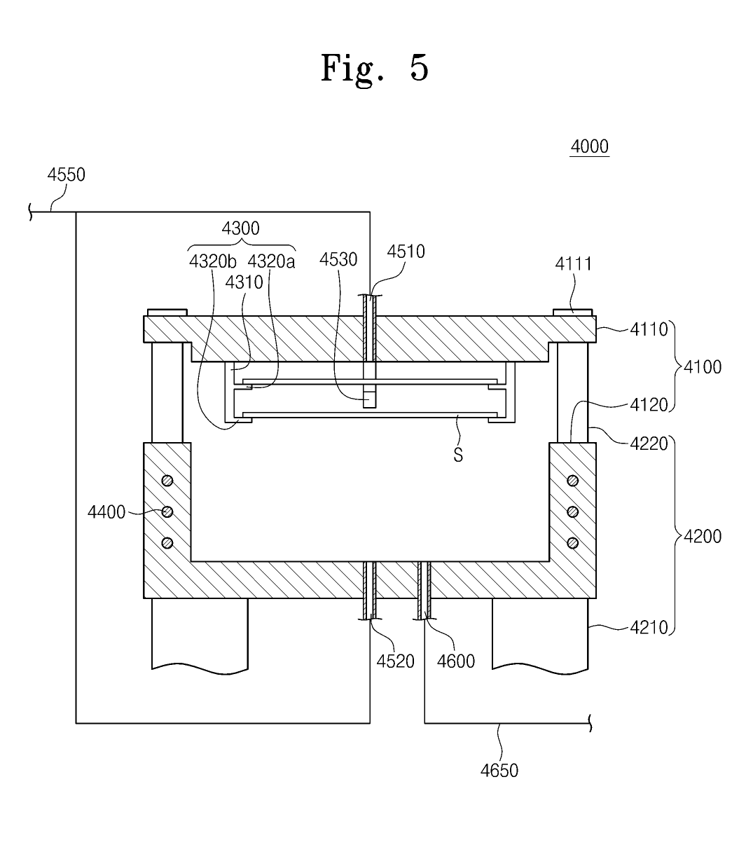

FIGS. 4 through 5 are sectional views illustrating the second process chamber 4000 depicted in FIG. 2, according to an embodiment of the present invention.

Referring to FIGS. 4 through 5, the second process chamber 4000 may include a housing 4100, a lift member 4200, a support unit 4300, a heating member 4400, supply ports 4500, and an exhaust port 4600.

The housing 4100 provides a space in which a supercritical drying process can be performed. The housing 4100 is formed of a material resistant to high pressures equal to or higher than a critical pressure.

The housing 4100 may include an upper housing 4110 and a lower housing 4120 under the upper housing 4110.

The upper housing 4110 may be fixed, and the lower housing 4120 may be lifted. If the lower housing 4120 is lowered away from the upper housing 4110, the inside of the second process chamber 4000 is opened, and thus a substrate (S) can be carried into or out of the second process chamber 4000. A substrate (S) on which an organic solvent remains after an organic solvent process performed in the first process chamber 3000 may be carried into the second process chamber 4000. If the lower housing 4120 is moved upward onto the upper housing 4110, the inside of the second process chamber 4000 is closed, and then a supercritical drying process may be performed in the second process chamber 4000. In another embodiment of the housing 4100, the lower housing 4120 may be fixed, and the upper housing 4110 may be lifted.

The lift member 4200 is used to vertically move the lower housing 4120. The lift member 4200 may include lift cylinders 4210 and lift rods 4220. The lift cylinders 4210 are coupled to the lower housing 4120 to apply vertical driving forces (i.e., lifting or lowering forces) to the lower housing 4120. The lift cylinders 4210 generates driving forces sufficient to keep the upper housing 4110 and the lower housing 4120 in contact with each other to firmly close the second process chamber 4000 although the inside pressure of the second process chamber 4000 increases to a critical pressure or higher during a supercritical drying process. The lift rods 4220 have: ends inserted in the lift cylinders 4210; and the other ends vertically extending from the ends and coupled to the upper housing 4110. In this structure, if the lift cylinders 4210 generate driving forces, the lift cylinders 4210 and the lift rods 4220 may be relatively moved to lift the lower housing 4120 coupled to the lift cylinders 4210. While the lower housing 4120 is lifted by the lift cylinders 4210, the lift rods 4220 guides the lower housing 4120 so that the upper housing 4110 and the lower housing 4120 can be prevented from moving horizontally from proper positions.

The support unit 4300 may support a plurality of substrates (S) in the housing 4100. The support unit 4300 may include support bars 4310 and a plurality of support members 4320.

The support bars 4310 may extend downward from an upper wall of the housing 4100 (i.e., a lower surface of the upper housing 4110). One or two pairs of horizontally-arranged support bars 4310 may be provided.

The support members 4320 extend from the support bars 4310 at predetermined intervals.

The support members 4320 may extend horizontally from the support bars 4310. For example, first support members 4320a may extend horizontally from middle parts of the support bars 4310, and second support members 4320b may horizontally extend from the lower ends of the support bars 4310. If two pairs of support bars 4310 are provided at predetermined intervals, the support members 4320 extending from the support bars 4310 toward each other.

The number of the support bars 4310 is not limited. That is, if necessary, the number of the support bars 4310 may be increased or decreased.

The support members 4320 may support edge regions of substrates (S). A pair of support bars 4310 may be spaced apart from each other by a distance greater than the diameter of a substrate (S), and the support members 4320 may extend from mutually facing sides of the support bars 4310. In this structure, the support members 4320 may support edge regions of substrates (S) in a manner such that both the front and rear sides of the substrates (S) can be exposed in the housing 4100 to be dried by a supercritical fluid. The front sides of the substrates (S) may be patterned sides, and the rear sides of the substrates (S) may be non-patterned sides.

As described above, since the support unit 4300 supports a plurality of substrates (S) in the housing 4100, the plurality of substrates (S) can be dried at a time in the second process chamber 4000 through a supercritical drying process.

In addition, since the support unit 4300 is disposed on the fixed upper housing 4110, the support unit 4300 may stably support substrates (S) while the lower housing 4120 is lifted and lowered.

Level adjustment members 4111 may be disposed on the upper housing 4110 on which the support unit 4300 is disposed. The level adjustment members 4111 are used to control the horizontality of the upper housing 4110. If the horizontality of the upper housing 4110 is adjusted, the horizontality of substrates (S) placed on the support unit 4300 of the upper housing 4110 may also be adjusted. If substrates (S) are not horizontally positioned in a supercritical drying process, an organic solvent may flow down on the substrates (S), and thus some portions of the substrates (S) may not be dried or may be excessively dried. However, the horizontality of substrates (S) can be adjusted using the level adjustment members 4111 to prevent such situations. If the upper housing 4110 is vertically movable and the lower housing 4120 is fixed, or if the support unit 4300 is disposed on the lower housing 4120, the level adjustment members 4111 may be disposed on the lower housing 4120.

The heating member 4400 is used to heat the inside of the second process chamber 4000. The heating member 4400 may heat a supercritical fluid supplied into the second process chamber 4000 to a critical temperature or higher so as to maintain the supercritical fluid in a supercritical state or return the supercritical fluid into the supercritical state if the supercritical fluid liquefies. The heating member 4400 may be buried in a wall of at least one of the upper housing 4110 and the lower housing 4120. For example, a heater configured to generate heat from electricity received from an external power source may be used as the heating member 4400.

The supply ports 4500 supply a supercritical fluid to the second process chamber 4000.

The supply ports 4500 may be connected to supply lines 4550 to supply a supercritical fluid. Valves may be disposed at the supply ports 4500 to control the flow rates of a supercritical fluid supplied from the supply lines 4550.

The supply ports 4500 may be include an upper supply port 4510, a lower supply port 4520, and a nozzle member 4530.

The upper supply port 4510 is disposed in the upper housing 4110 to supply a supercritical fluid to the front side of the uppermost substrate (S) supported on the support unit 4300. The lower supply port 4520 is disposed in the lower housing 4120 to supply a supercritical fluid to the rear side of the lowermost substrate (S) supported on the support unit 4300.

The upper supply port 4510 and the lower supply port 4520 may supply a supercritical fluid to center regions of the substrates (S). For example, the upper supply port 4510 may be located above a substrate (S) supported on the support unit 4300 and aligned with the center of the substrate (S). The lower supply port 4520 may be located under a substrate (S) supported on the support unit 4300 and aligned with the center of the substrate (S). Then, a supercritical fluid injected through the upper supply port 4510 and the lower supply port 4520 may first reach center regions of substrates (S) and spread to edge regions of the substrates (S), so as to dry the substrates (S).

When viewed from the side, an end of the nozzle member 4530 for injecting a supercritical fluid may be disposed between neighboring support members 4320 (i.e., between neighboring substrates (S)). A plurality of nozzle members 4530 may be disposed between the support members 4320, respectively. The nozzle member 4530 may extend downward from an upper wall of the housing 4100 (i.e., from the upper housing 4110) and may be horizontally bent at a middle position between the support members 4320 of the support bars 4310. Then, the nozzle member 4530 may extend toward a substrate center position. When viewed from the side, the end of the nozzle member 4530 may be disposed between neighboring substrates (S), and when viewed from the top, the end of the nozzle member 4530 may be aligned with a center region of a substrate (S).

A supercritical fluid may be injected through the end of the nozzle member 4530 toward the lower one of two neighboring substrates (S). Since a substrate (S) is placed on the support unit 4300 with a patterned side of the substrate (S) being upward, drying of the topside of the substrate (S) may be more meaningful. The topside of a substrate (S) placed on the first support members 4320a may receive a supercritical fluid from the upper supply port 4510, and the topside of a substrate (S) placed on the second support members 4320b may receive a supercritical fluid from the nozzle member 4530. Thus, a plurality of substrates (S) may be simultaneously dried through a supercritical drying process.

A supercritical fluid may be supplied through the lower supply port 4520 and then the upper supply port 4510 and the nozzle member 4530. In an early stage of a supercritical drying process, the inside pressure of the second process chamber 4000 may be lower than a critical pressure, and thus a supercritical fluid supplied into the second process chamber 4000 may be liquefied. Therefore, if a supercritical fluid is supplied through the upper supply port 4510 or the nozzle member 4530 in an early stage of a supercritical drying process, the supercritical fluid may liquefy and fall to substrates (S) by gravity to damage the substrates (S). Thus, after a supercritical fluid is supplied to the second process chamber 4000 through the lower supply port 4520 and the inside pressure of the second process chamber 4000 reaches a critical pressure, a supercritical fluid may be supplied to the second process chamber 4000 through the upper supply port 4510 and the nozzle member 4530, so as to prevent the supercritical fluid from liquefying and falling to substrates (S).

The exhaust port 4600 discharges a supercritical fluid from the second process chamber 4000. The exhaust port 4600 may be connected to an exhaust line 4650 to discharge a supercritical fluid. A valve may be disposed at the exhaust port 4600 to control the flow rate of a supercritical fluid to be discharged through the exhaust line 4650. A supercritical fluid may be discharged through the exhaust line 4650 to the atmosphere or a supercritical fluid recycling system (not shown).

The exhaust port 4600 may be formed in the lower housing 4120. In a late stage of a supercritical drying process, the inside pressure of the second process chamber 4000 may be reduced below a critical pressure as a supercritical fluid is discharged from the second process chamber 4000, and thus the supercritical fluid filled in the second process chamber 4000 may be liquefied. The liquefied supercritical fluid may flow to the exhaust port 4600 formed in the lower housing 4120 by gravity and then flow to the outside through the exhaust port 4600.

In the above description, two substrates (S) are supported and treated at the same time in the second process chamber 4000. However, the number of substrates (S) that can be treated at the same time in the second process chamber 4000 is not limited thereto.

In addition, the upper supply port 4510 and the lower supply port 4520 of the second process chamber 4000 are optional elements. For example, the second process chamber 4000 may not include one or both of the upper supply port 4510 and the lower supply port 4520. If the second process chamber 4000 does not include the upper supply port 4510, another nozzle member 4530 may be provided between the uppermost support members 4320 and the upper wall of the housing 4100. The other nozzle member 4530 may supply a supercritical fluid to a substrate (S) placed on the uppermost support members 4320 instead of the upper supply port 4510.

In the above description, the support unit 4300 provided in the second process chamber 4000 includes the support bars 4310 and the support members 4320. However, the support unit 4300 may have a different structure. For example, the support unit 4300 may include slots like the buffer slot of the buffer chamber 2100. In detail, the support unit 4300 may be provided in the form of a pair of plates horizontally extending from a sidewall of the housing 4100. The pair of plates may support both edges of a substrate (S). A plurality of support units 4300 having slots may be vertically arranged along the sidewall of the housing 4100. In this case, a plurality of substrates (S) may be supported on the support units 4300.

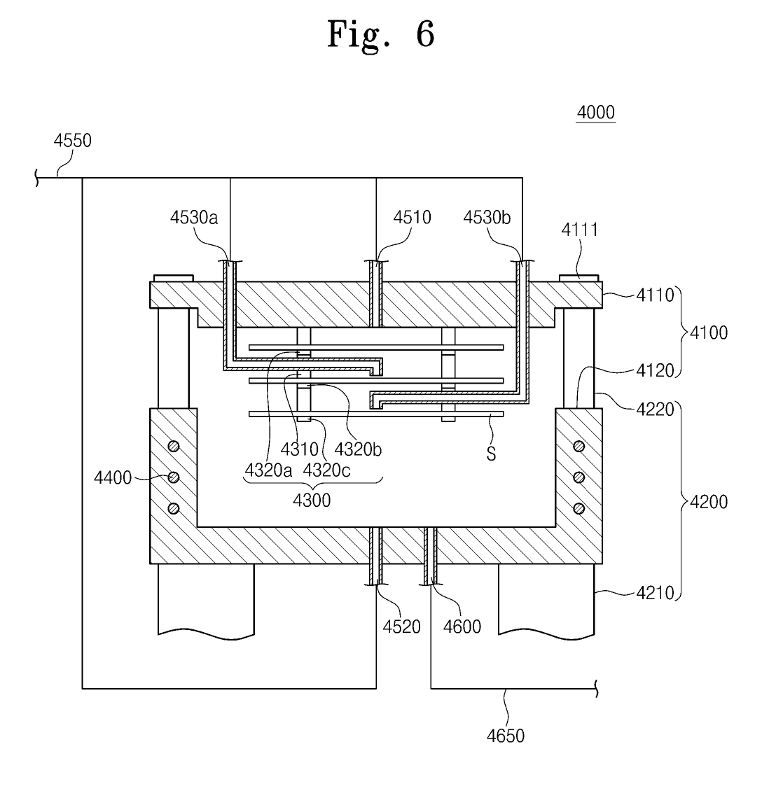

FIG. 6 is a sectional view illustrating the second process chamber 4000 according to another embodiment of the present invention.

Referring to FIG. 6, three support members 4320a, 4320b, and 4320c may be disposed on each support bar 4310 to support vertically arranged substrates (S). The nozzle member 4530 may include: a first nozzle member 4530a disposed between the first support member 4320a and the second support member 4320b: and a second nozzle member 4530b disposed between the second support member 4320b and the third support member 4320c. In this structure, a supercritical fluid may be injected to topsides of substrates (S) through the upper supply port 4510, the first nozzle member 4530a, and the second nozzle member 4530b. The second process chamber 4000 may be used to treat three substrates (S) at the same time.

In the above description, the nozzle member 4530 is used to inject a supercritical fluid to the topside of a lower substrate (S). However, the injection direction and type of the nozzle member 4530 are not limited thereto.

For example, the nozzle member 4530 may inject a supercritical fluid to the topside of a lower substrate (S) in a radial pattern instead of perpendicularly injecting the supercritical fluid to the topside of the lower substrate (S).

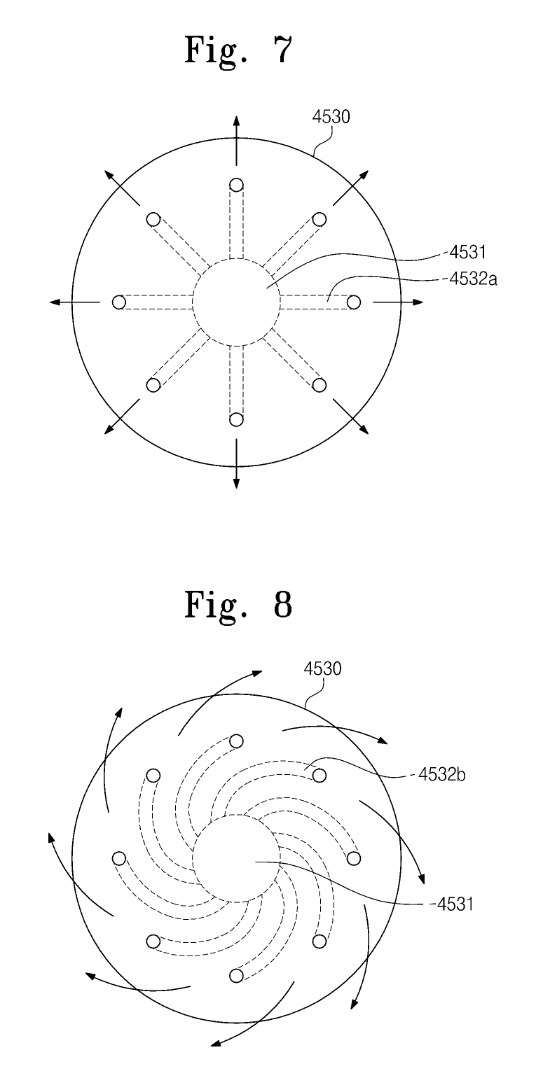

FIGS. 7 and 8 are views illustrating exemplary end shapes of the nozzle member 4530 explained with reference to FIGS. 4 and 5, and FIG. 9 is a view illustrating the nozzle member 4530 of FIG. 7 when a supercritical fluid is injected through the nozzle member 4530.

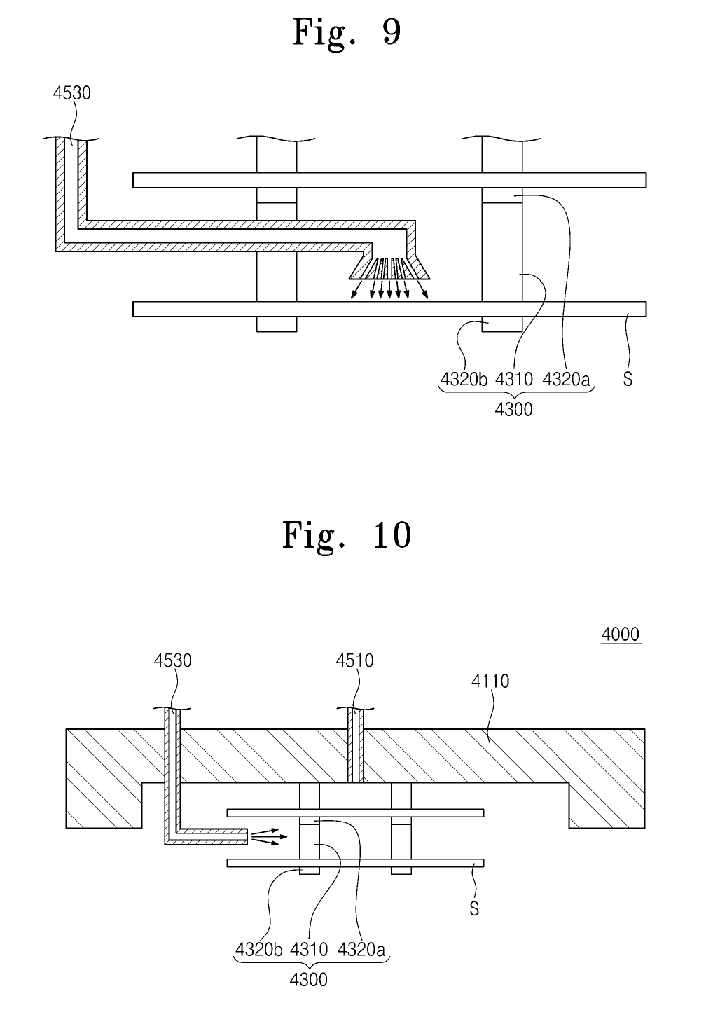

Referring to FIG. 7, a center hole 4531 may be formed through the nozzle member 4530 to allow a flow of a supercritical fluid, and small holes 4532a may be formed in the end of the nozzle member 4530 to guide the flow of the supercritical fluid outward from the center hole 4531. A supercritical fluid may flow through the center hole 4531 of the nozzle member 4530 and may be discharged at the end of the nozzle member 4530 through the small holes 4532a. Since the small holes 4532a extend radially from a center portion of the nozzle member 4530, a supercritical fluid may be injected radially and downwardly instead of being injected vertically downward. Therefore, as shown in FIG. 9, an injected supercritical fluid may have horizontal velocity components so as to rapidly spread from the center region to the edge region of a substrate (S). As a result, the supercritical fluid may be uniformly supplied to the entirety of the substrate (S).

Referring to FIG. 8, screw type small holes 4532b are formed through the end of the nozzle member 4530 instead of the radial small holes 4532a. A supercritical fluid injected through the small holes 4532b may whirl, and owing to the whirling, the supercritical fluid may be uniformly supplied to the entirety of a substrate (S).

The nozzle member 4530 may not inject a supercritical fluid toward the topside of a lower substrate (S). For example, the nozzle member 4530 may inject a supercritical fluid toward the bottom side of an upper substrate (S) or toward both the bottom side of an upper substrate (S) and the topside of a lower substrate (S).

In addition, the end of the nozzle member 4530 may not be aligned with a center portion of a substrate (S).

FIG. 10 is a view illustrating a modification example of the nozzle member 4530 explained with reference to FIGS. 4 and 5.

Referring to FIG. 10, when viewed from the top, an end of the nozzle member 4530 may be located at an edge of a substrate (S) or outside the substrate (S). The nozzle member 4530 may inject a supercritical fluid to a gap between neighboring substrates (S). In this case, the supercritical fluid may be injected through the nozzle member 4530 in parallel with top and bottom sides of the substrates (S). In this way, if a supercritical fluid is injected at an edge or outside position of a substrate (S), owing to a horizontal velocity component, the supercritical fluid may be supplied to the entirety of the substrate (S) while the supercritical fluid flows in the order of an edge region, a center region, and an opposite edge region of the substrate (S). In addition, the supercritical fluid may be supplied to both the bottom side of the upper substrate (S) and the topside of the lower substrate (S).

While the present invention has been explained for the case where the substrate treating apparatus 100 treats substrates (S) using a supercritical fluid, the substrate treating apparatus 100 of the present invention is not limited to performing such a supercritical drying process. For example, the substrate treating apparatus 100 may be used to treat substrates (S) by supplying a different process fluid into the second process chamber 4000 through the supply ports 4500 instead of supplying a supercritical fluid. For example, organic solvents, gases having various ingredients, plasma gases, or inert gases may be used instead of a supercritical fluid.

In addition, the substrate treating apparatus 100 may further include a controller for controlling elements of the substrate treating apparatus 100. For example, the controller may control the heating member 4400 to adjust the inside temperature of the housing 4100. In another example, the controller may control the valves disposed at the supply lines 4550 or the exhaust line 4650 to adjust the flow rates of a chemical or a supercritical fluid. In another example, under the control of the controller, a supercritical fluid may be supplied through one of the upper supply port 4510 and the lower supply port 4520, and if the inside pressure of the second process chamber 4000 reaches a preset value, the supercritical fluid may be supplied through the other of the upper supply port 4510 and the lower supply port 4520.

The controller may be hardware, software, or a device such as a computer provided as a combination of hardware and software.

For example, the controller may be hardware such as ASICs (application specific integrated circuits), DSPs (digital signal processors), DSPDs (digital signal processing devices), PLDs (programmable logic devices), FPGAs (field programmable gate arrays), processors, micro-controllers, microprocessors, and electric devices having similar control functions.

For example, the controller may be software such as a software code or application written in at least one programming language. Software may be executed by a control unit provided in the form of hardware. Alternatively, software may be transmitted from an external device such as a server to hardware and may be installed on the hardware.

Hereinafter, a substrate treating method will be explained using the substrate treating apparatus 100 according to an embodiment of the present invention. Although the substrate treating method is explained using the substrate treating apparatus 100 in the following description, the substrate treating method may be performed using another apparatus similar to the substrate treating apparatus 100. In addition, the substrate treating method of the present invention may be stored in a computer-readable recording medium in the form of an executable code or program.

Hereinafter, an embodiment of the substrate treating method of the present invention will be explained. The embodiment relates to a cleaning process in general.

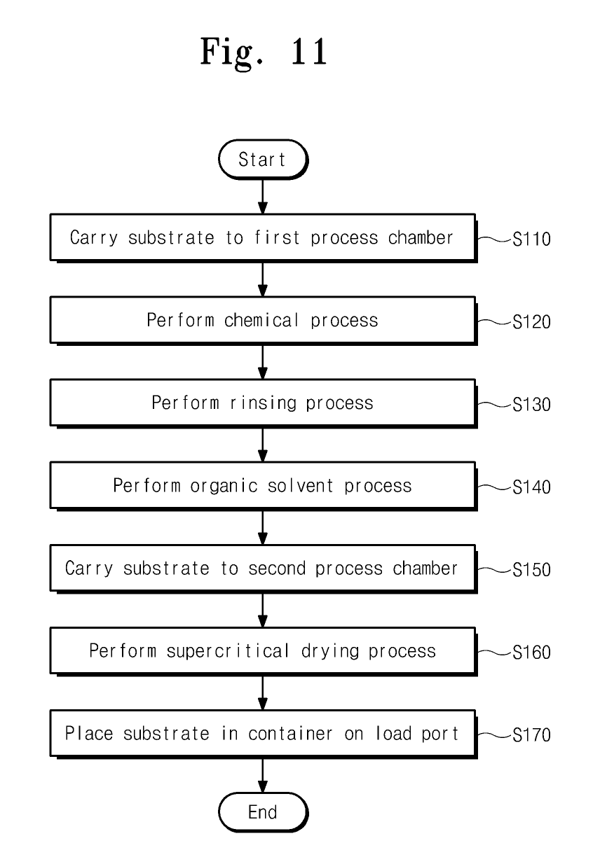

FIG. 11 is a flowchart for explaining a substrate treating method according to an embodiment of the present invention.

Referring to FIG. 11, the substrate treating method of the current embodiment includes: operation 5110 in which a substrate (S) is carried into the first process chamber 3000; operation S120 in which a chemical process is performed; operation S130 in which a rinsing process is performed; operation S140 in which an organic solvent process is performed; operation S150 in which substrates (S) are carried into the second process chamber 4000; operation S160 in which a supercritical drying process is performed; and operation S170 in which the substrates (S) are put in a container (C) placed in the load port 1100. The above-listed operations are not required to be performed in the listed order. For example, an operation listed later may be performed prior to an operation listed first. This is equal in other embodiments of the substrate treating method. The operations will now be explained in detail.

A substrate (S) is carried into the first process chamber 3000 (S110). First, a container (C) in which substrates (S) are stored is placed on the load port 1100 by a carrying device such as an OHT. Then, the index robot 1210 picks up a substrate (S) from the container (C) and places the substrate (S) in a buffer slot. The transfer robot 2210 picks up the substrate (S) from the buffer slot and carries the substrate (S) into the first process chamber 3000. The substrate (S) is placed on the support plate 3110 in the first process chamber 3000.

Thereafter, a chemical process is performed (S120). After the substrate (S) is placed on the support plate 3110, the nozzle shaft 3230 is moved and rotated by the nozzle shaft actuator 3240 to place the nozzle 3210 directly above the substrate (S). A detergent is injected to the topside of the substrate (S) through the nozzle 3210. Contaminants are removed from the substrate (S) as the detergent is injected. At this time, the rotary actuator 3130 rotates the rotation shaft 3120 to rotate the substrate (S). As the substrate (S) is rotated, the detergent may be uniformly supplied to the substrate (S) and scatter from the substrate (S). The detergent scattering from the substrate (S) is collected in the collecting vessels 3310 where the detergent is discharged to a fluid recycling system (not shown) through the collecting line 3320. At this time, the lift actuator 3340 lifts or lowers the collecting vessels 3310 so that the scattering detergent can be collected in one of the collecting vessels 3310.

After contaminants are sufficiently removed from the substrate (S), a rinsing operation is performed (S130). After the chemical process, the detergent remains on the substrate (S) although contaminants are removed from the substrate (S). The nozzle 3210 through which the detergent is injected is moved away from the topside of the substrate (S), and another nozzle 3210 is moved to a position directly above the substrate (S) to inject a rinsing agent to the topside of the substrate (S). The rinsing agent supplied to the substrate (S) cleans the detergent remaining on the substrate (S). During the rinsing process, the substrate (S) may be rotated, and a chemical may be collected. The lift actuator 3340 adjusts the height of the collecting vessels 3310 so that the rinsing agent can be collected in one of the collecting vessels 3310 different from that used to collect the detergent.

After the substrate (S) is sufficiently rinsed, an organic solvent process is performed (S140). After the rinsing process, another nozzle 3210 is moved to a position directly above the substrate (S) to inject an organic solvent to the substrate (S). The rinsing agent remaining on the substrate (S) is replaced with the organic solvent. In the organic solvent process, the substrate (S) may not be rotated or may be rotated at low speed. The reason for this is that if the organic solvent evaporates soon, the surface tension of the organic solvent may cause interfacial tension between circuit patterns of the substrate (S) to make the circuit patterns collapse.

After the organic solvent process in the first process chamber 3000, the substrate (S) is carried to the inside of the second process chamber 4000 (S150), and a supercritical drying process is performed in the second process chamber 4000 (S160). The operations S150 and S160 will be explained later in more detail when another embodiment of the substrate treating method is explained.

After the supercritical drying process, the substrate (S) is carried from the second process chamber 4000 into the container (C) placed on the load port 1100 (S170). For this, the second process chamber 4000 is opened, and the transfer robot 2210 picks up the substrate (S). The substrate (S) may be carried to the buffer chamber 2100 by the transfer robot 2210, and the index robot 1210 may carry the substrate (S) from the buffer chamber 2100 to the container (C).

Hereinafter, another embodiment of the substrate treating method of the present invention will be explained. The other embodiment of the substrate treating method relates to a supercritical drying process in the second process chamber 4000.

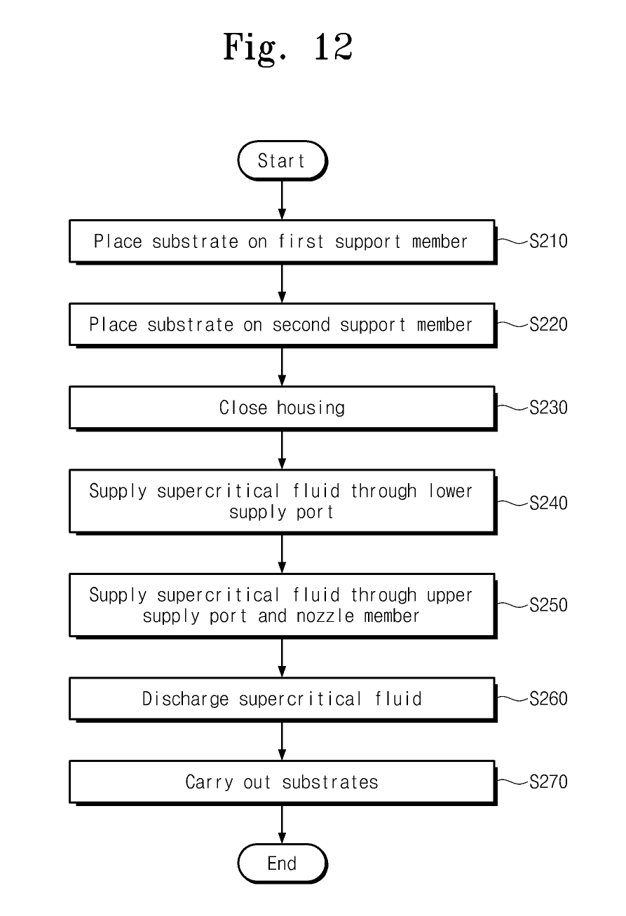

FIG. 12 is a flowchart for explaining the other embodiment of the substrate treating method.

Referring to FIG. 12, the substrate treating method of the other embodiment may include: operation S210 in which a substrate (S) is placed on the first support members 4320a; operation S220 in which a substrate (S) is placed on the second support members 4320b; operation S230 in which the housing 4100 is closed; operation S240 in which a supercritical fluid is supplied through the lower supply port 4520; operation S250 in which a supercritical fluid is supplied through the upper supply port 4510 and the nozzle member 4530; operation S260 in which the supercritical fluid is discharged; and operation S270 in which the substrates (SS) are carried out. The operations will now be explained in detail.

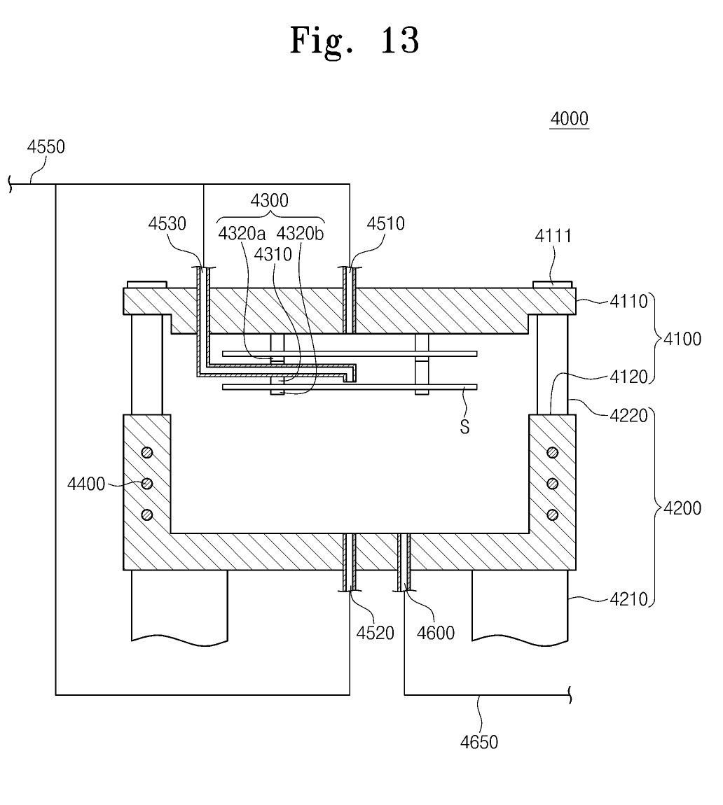

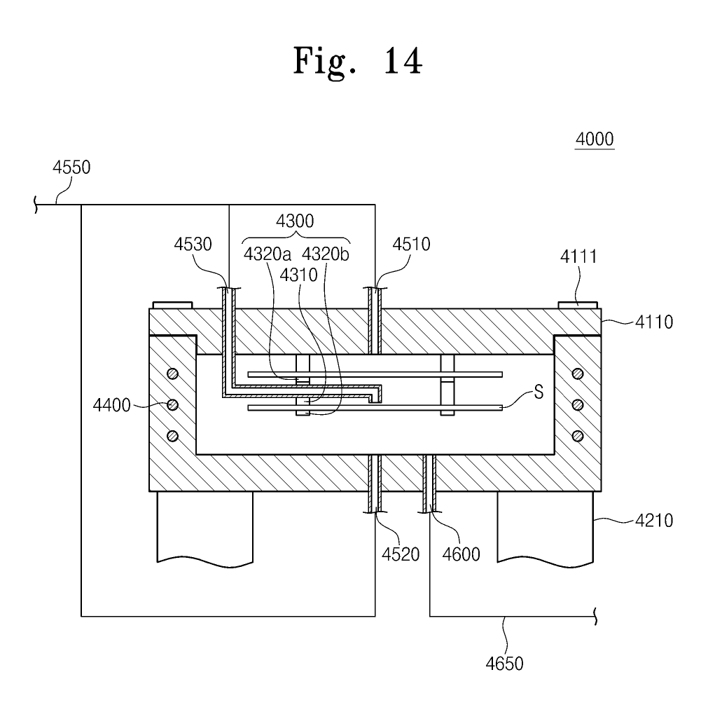

FIGS. 13 and 14 are views illustrating the second process chamber 400 when the substrate treating method of FIG. 12 is performed.

Referring to FIG. 13, the transfer robot 2210 carries a substrate (S) into the second process chamber 4000 and place the substrate (S) on the first support members 4320a (S210), and the transfer robot 2210 carries another substrate (S) into the second process chamber 4000 and places the other substrate (S) on the second support members 4320b. The substrates (S) on which an organic solvent remains after an organic solvent process performed in the first process chamber 3000 may be carried into the second process chamber 4000.

At this time, the operation S210 may be performed prior to operation S220, or operation S220 may be performed prior to operation S210, or operations S210 and S220 may be performed at the same time. The housing 4100 may be opened in a state where the upper housing 4110 and the lower housing 4120 are spaced apart from each other.

Referring to FIG. 14, after the substrates (S) are placed, the lift member 4200 lifts the lower housing 4120 to couple the lower housing 4120 with the upper housing 4110. Then, the housing 4100 or the second process chamber 4000 is closed (S230).

After the second process chamber 4000 is closed, a supercritical fluid is supplied to a lower inside region of the second process chamber 4000 through the lower supply port 4520 (S240). The supercritical fluid may be a supercritical carbon dioxide. In the above operations, the heating member 4400 may heat the inside of the housing 4100.

As the supercritical fluid is supplied into the second process chamber 4000, the inside temperature and pressure of the second process chamber 4000 become higher than a critical temperature and pressure so that the inside of the second process chamber 4000 can be in a supercritical state.

Thereafter, a supercritical fluid is supplied through the upper supply port 4510 and the nozzle member 4530. The supercritical fluid is supplied to patterned sides of the substrates (S) placed on the support members 4320, and the substrates (S) are dried as an organic solvent remaining between circuit patterns of the substrates (S) is dissolved in the supercritical fluid.

Since the substrate (S) placed on the first support members 4320a receives a supercritical fluid from the upper supply port 4510 and the substrate (S) placed on the second support member 4320b receives a supercritical fluid from the nozzle member 4530, a supercritical drying process may be effectively performed on the two substrates (S).

After the substrates (S) are sufficiently dried, the supercritical fluid and substances generated during the supercritical drying process are discharged from the second process chamber 4000 (S260). As a result, the inside pressure of the second process chamber 4000 may become close to the atmospheric pressure. After the inside pressure of the second process chamber 4000 is sufficiently reduced, the lift member 4200 lowers the lower housing 4120 to open the second process chamber 4000, and the transfer robot 2210 carries the substrates (S) out of the second process chamber 4000 (S270). In operation S250, if the supercritical fluid is saturated with the dissolved organic solvent or other substances, the efficiency of drying may be lowered. Therefore, the supercritical fluid used in the supercritical drying process may be discharged, and a new supercritical fluid may be supplied. That is, operations S250 and S260 may be performed several times to repeat supply and discharge of a supercritical fluid.

According to the present invention, a plurality of substrates can be treated at the same time in one process chamber.

In addition, according to the present invention, since a supercritical fluid is injected through the nozzle member disposed between vertically arranged substrates, the supercritical fluid can be supplied to the substrates at the time and thus the efficiency of a process can be improved.

The present invention is not limited thereto. Other features and spirit of the present invention will be apparently understood by those skilled in the art through the above description and accompanying drawings.

The above-described embodiments are given so that those of skill in the related art could easily understand the present invention, and are not intended to limit the present invention.

Thus, the embodiments and elements thereof can be used in other ways or with known technology, and various modifications and changes in form and details can be made without departing from the scope of the present invention.

In addition, the scope of the present invention is defined by the following claims, and all differences within the scope will be considered as being included in the present invention.

What is claimed is:

1. An apparatus for treating substrates, the apparatus comprising:
a housing providing a space for performing a process; and
a plurality of support members vertically arranged in the housing at predetermined intervals to support edges of substrates, respectively.

2. The apparatus of claim 1, further comprising a nozzle member having an end through which a process fluid is injected, the end being disposed between neighboring substrates when viewed from a side.

3. The apparatus of claim 2, wherein the end of the nozzle member is aligned with a center portion of a substrate when viewed from a top.

4. The apparatus of claim 3, wherein the nozzle member injects the process fluid toward a topside of a lower one of the neighboring substrates.

5. The apparatus of claim 3, wherein the nozzle member injects the process fluid toward both a topside of a lower one of the neighboring substrates and a bottom side of an upper one of the neighboring substrates.

6. The apparatus of claim 4, wherein the nozzle member injects the process fluid in a radial pattern in oblique directions from a vertical direction.

7. The apparatus of claim 2, wherein the end of the nozzle member is positioned at an edge portion of a substrate or outside the substrate to inject the process fluid in a direction parallel with the substrate.

8. The apparatus of claim 2, further comprising a lower supply port disposed in a lower wall of the housing for injecting the process fluid.

9. The apparatus of claim 8, further comprising an upper supply port disposed in an upper wall of the housing for injecting the process fluid.

10. The apparatus of claim 8, further comprising a controller configured to control supply of the process fluid in a manner such if an inside pressure of the housing reaches a preset value after the process fluid is supplied through the lower supply port, the nozzle member starts to inject the process fluid.

11. The apparatus of claim 1, further comprising a support bar extending downward from an upper wall of the housing,
wherein the support members are disposed on the support bar at regular intervals.

12. The apparatus of claim 1, wherein the housing comprises an upper housing and a lower housing under the upper housing, and
the apparatus further comprises a lift member configured to lift or lower one of the upper housing and the lower housing to close or open the housing.

13. The apparatus of claim 1, wherein the process fluid is a supercritical fluid.

14. An apparatus for treating substrates, the apparatus comprising:
a housing providing a space for performing a process;
a first support member configured to support an edge of a first substrate;
a second support member configured to support an edge of a second substrate; and
an upper supply port disposed in an upper wall of the housing to inject a supercritical fluid to a topside of the second substrate.

15. The apparatus of claim 14, further comprising a nozzle member having an end through which the supercritical fluid is injected, the end being disposed between the first and second support members when viewed from a side.

16. The apparatus of claim 15, wherein the nozzle member injects the supercritical fluid toward a topside of the second substrate.

17. The apparatus of claim 15, wherein the nozzle member injects the supercritical fluid to a gap between the first and second substrates.

18. The apparatus of claim 14, further comprising a support bar extending downward from the upper wall of the housing,
wherein the first support member extends horizontally from a lower end of the support bar, and
the second support member extends horizontally from a middle of the support bar.

19. A method for treating substrates, the method comprising:
placing a plurality of substrates on a plurality of support members vertically arranged at predetermined intervals in a housing proving a space for performing a process, the support members supporting edges of the substrates; and
injecting a process fluid through a nozzle member for treating the substrates at the same time, an end of the nozzle member being disposed between neighboring substrates when viewed from a side.

20. The method of claim 19, wherein the nozzle member injects the process fluid toward a topside of a lower one of the neighboring substrates so as to treat the topside of the lower substrate.

21. The method of claim 19, wherein the nozzle member injects the process fluid to a gap between the neighboring substrates so as to simultaneously treat a bottom side of an upper one of the neighboring substrates and a topside of a lower one of the neighboring substrates.

22. The method of claim 19, wherein the housing comprises an upper housing and a lower housing under the upper housing,
wherein the housing is opened or closed by lowering or lifting one of the upper housing and the lower housing, the substrates are carried into and out of the housing when the housing is opened, and a process is performed in the housing when the housing is closed.

23. The method of claim 19, wherein the process fluid is a supercritical fluid.
